(19) United States
(12) Patent Application Publication
(10) Pub. No.: US 2023/0179590 A1
(43) Pub. Date: Jun. 8, 2023

(54) DEVICE AND METHOD FOR MANAGING CREDENTIALS

(71) Applicant: ELECTRONICS AND TELECOMMUNICATIONS RESEARCH INSTITUTE, Daejeon (KR)

(72) Inventors: Seok Hyun KIM, Daejeon (KR); Young Seob CHO, Daejeon (KR); Soo Hyung KIM, Daejeon (KR); Geon Woo KIM, Daejeon (KR); Young Sam KIM, Daejeon (KR); Jong Hyouk NOH, Daejeon (KR); Kwan Tae CHO, Daejeon (KR); Sang Rae CHO, Daejeon (KR); Jin Man CHO, Daejeon (KR); Seung Hun JIN, Daejeon (KR)

(73) Assignee: ELECTRONICS AND TELECOMMUNICATIONS RESEARCH INSTITUTE, Daejeon (KR)

(21) Appl. No.: 17/986,013

(22) Filed: Nov. 14, 2022

(30) Foreign Application Priority Data
Dec. 7, 2021 (KR) 10-2021-0174105

(51) Int. Cl. H04L 9/40; H04L 9/32

(52) U.S. Cl. CPC H04L 63/083; H04L 9/3247

(57) ABSTRACT

Disclosed are a device and method for managing credentials. In a multi-decentralized identity management service environment, a user can safely manage credentials that have been once issued, and can use the credentials in various user terminals without being redundantly issued credentials.

### CROSS-REFERENCE TO RELATED APPLICATION

This application claims priority to and the benefit of Korean Patent Application No. 10-2021-0174105, filed on Dec. 7, 2021, the disclosure of which is incorporated herein by reference in its entirety.

### BACKGROUND

### 1. Technical Field

The present disclosure relates to a device and method for managing credentials, which can safely store, manage, and use credentials based on a decentralized identifier (DID).

### 2. Related Art

Recently, a decentralized identifier (DID) based on which a user himself or herself can manage and control his or her identity information without a centralized registration institute is used in various digital industry fields. In particular, the DID is used in various digital certificate services, such as mobile driving licenses and vaccination certificates, along with the verifiable credential standard of W3C.

FIG. 1 is a diagram illustrating a DID-based decentralized identity management service environment. The decentralized identity management service consists of entities, such as an issuer, a user, a verifier, and a DID trust registry. The issuer issues credentials for the user. The user manages the issued credentials, and submits, to the verifier, the credentials that are necessary to use a service. The verifier requests, from the user, the credentials that are necessary to provide the service, verifies the credentials submitted by the user, and provides the service. The DID trust registry stores and manages DIDs indicative of the identities of the issuer, the user, and the verifier and a decentralized identifier document.

FIGS. 2A-2E illustrate a multi-decentralized identity management service. FIGS. 2A-2E illustrate a form in which apps a, b, c, and d distributed by decentralized identity management services A, B, C, and D have been installed in a single user terminal. As decentralized identity management services are recently used in various fields, there has come a multi-decentralized identity management service environment in which a user manages credentials issued through two or more decentralized identity management services and a verifier verifies the credentials of the user issued by the different decentralized identity management services and provides services.

FIG. 3 is a diagram illustrating a form in which a user uses a plurality of user terminals in a multi-decentralized identity management service environment. The user in the multi-decentralized identity management service environment may use multiple user terminals. In such a user environment, an application (or app) for being issued credentials and managing the credentials needs to be installed for each user terminal. Accordingly, the same credentials have to be inconveniently redundantly issued for each user terminal. Furthermore, there is a problem in that it is difficult for a user to conveniently inquire about proper credentials and submit the credentials when using a service because it is difficult for the user to previously confirm various credentials that are stored and managed for each app.

If a decentralized identity management service function is applied to various service fields in the future, it is expected that inconvenience in managing and using credentials will be increased because the range of apps that need to be managed by a user is further increased. Accordingly, there is a need for a credential management scheme capable of safely integrating and managing credentials and conveniently inquiring about and using credentials, if necessary, in a multi-decentralized identity management service environment in which a user uses a plurality of user terminals and apps.

### SUMMARY

Various embodiments are directed to providing a device and method for managing credentials, which safely integrate and manage credentials through an access control policy for an app and a key management interface in which a private key is managed as a secure element, conveniently inquire about credentials owned by a user through an interface for an app if credentials need to be submitted to the outside, and enable credentials at a specific terminal of a user to be used in another terminal of the same user by synchronizing and processing the credentials, in a multi-decentralized identity management service environment in which a user uses a plurality of user terminals and apps.

Objects of the present disclosure are not limited to the aforementioned object, and other objects not described above may be evidently understood by those skilled in the art from the following description.

In an embodiment, a credential management system includes a credential synchronization server capable of transmitting and receiving information to and from a plurality of user terminals, a first user terminal configured to be issued credentials and transmit, to the credential synchronization server, credential synchronization information including encoding information and private key information of the credentials, and a second user terminal configured to receive the credential synchronization information from the credential synchronization server and generate “signed verifiable presentation” based on the credential synchronization information when receiving a submission request for the credentials from a service provider.

The first user terminal may transmit, to the credential synchronization server, the credential synchronization information including a KeyID of the private key. The second user terminal may receive a digital signature for the credentials by requesting the digital signature from the first user terminal when receiving the submission request, and may generate the “signed verifiable presentation” based on the credential synchronization information and the digital signature. The private key may be generated by a secure element embedded in the first user terminal with respect to the credentials.

Furthermore, the first user terminal may transmit, to the credential synchronization server, the credential synchronization information including the encoding information of the credentials and encoding information of the private key. The second user terminal may generate the digital signature for the credentials based on the private key encoding information in response to the submission request and generate the “signed verifiable presentation” based on the credential synchronization information and the digital signature. The private key may be generated with respect to the credentials.

Furthermore, in a credential manager installed in a user terminal, the credential manager according to an embodiment of the present disclosure includes a credential management interface configured to receive a registration request for credentials from an app installed in the user terminal, a credential information management unit configured to register the credentials and store encoding information of the credentials and private key information of the credentials in an internal repository of the credential manager, and a credential synchronization unit configured to transmit credential synchronization information including the encoding information of the credentials and the private key information of the credentials to credential synchronization server capable of transmitting and receiving information to and from the user terminal and another terminal of the user.

The credential manager may further include a user authentication unit configured to perform a user authentication procedure on the credentials in response to a registration request for the credentials. The credential information management unit may register the credentials and store the credentials in the internal repository, when the user authentication procedure is completed.

The credential information management unit may generate a digital signature based on private key encoding information when the private key information of the credentials for which digital signature has been requested by the app installed in the user terminal is private key encoding information.

The credential manager may further include a key management interface capable of operating a secure element of the user terminal. In this case, the credential information management unit may transmit a KeyID to the key management interface when the private key information of the credentials for which digital signature has been requested by the app installed in the user terminal is the KeyID and a terminal that owns the original of the private key of the credentials for which digital signature has been requested by the app is the user terminal. The key management interface may invoke a digital signature function of a secure element of the user terminal by using the KeyID as an argument so that the secure element generates a digital signature for the credentials for which digital signature has been requested by the app by using a private key having the KeyID, may receive the digital signature, and may transmit the digital signature to the credential information management unit.

The credential synchronization unit may receive, from the credential synchronization server, credential synchronization information including credential encoding information and private key information of credentials issued by the another terminal, and may transmit the credential synchronization information to the credential information management unit. The credential information management unit may confirm a terminal that owns private key information of credentials for which digital signature has been requested by the app installed in the user terminal and the original of the private key, may request a digital signature from the another terminal when the private key information is a KeyID and the terminal that owns the original of the private key is the another terminal, and may receive a digital signature using the private key from the another terminal.

The credential management interface may receive at least any one of inquiry, update, and deletion requests for the credentials from the app installed in the user terminal. The credential information management unit may perform any one of the inquiry, update, and deletion of the credentials in response to the request.

The credential synchronization information may further include push information that enables a credential manager installed in the another terminal to invoke the credential manager.

The credential synchronization server may transmit the credential synchronization information to the another terminal.

The credential manager may further include a credential access control unit configured to control the app installed in the user terminal to access the credentials stored in the internal repository according to a given access policy.

The credential manager may further include a key management interface capable of operating a secure element of the user terminal. In this case, the credential information management unit may confirm a terminal that owns a type of the private key information of the credentials and the original of the private key of the credentials when the another terminal requests a digital signature for the credentials, and may transmit a KeyID to the key management interface when the private key information is the KeyID and the terminal that owns the original of the private key of the credentials is the user terminal. The key management interface may invoke a digital signature function of a secure element of the user terminal by using the KeyID as an argument so that the secure element generates a digital signature for the credentials by using a private key having the KeyID, may receive the digital signature, and may transmit the digital signature to the credential information management unit.

Furthermore, in a method of registering, by a credential manager installed in a user terminal, credentials, the method of registering credentials according to an embodiment of the present disclosure includes a step of receiving a request for the registration of credentials from an app installed in the user terminal, a step of registering the credentials when user authentication for the registration of the credentials is completed, and a credential synchronization step of transmitting encoding information and private key information of the registered credentials to a credential synchronization server accessible to another terminal of the user.

The credential synchronization step may include additionally transmitting, to the credential synchronization server, push information that enables a credential manager installed in the another terminal of the user to invoke the credential manager installed in the user terminal.

Furthermore, the credential synchronization step may include additionally transmitting, to the credential synchronization server, an identifier of the user terminal, a decentralized identifier (DID) of the credential manager, and ID information of an app of the user terminal whose access to the credentials has been blocked.

Furthermore, in a method of generating “signed verifiable presentation” through a credential manager installed in a user terminal, the method of generating “signed verifiable presentation” according to an embodiment of the present disclosure includes a step of selecting, by the app of the user terminal, credentials to be submitted to a service provider outside the user terminal and generating verifiable presentation by using the selected credentials, a step of requesting, by the app, a digital signature for the verifiable presentation from the credential manager installed in the user terminal, a step of determining, by the credential manager installed in the user terminal, information type of a private key of the credentials corresponding to the verifiable presentation, a step of generating, by the credential manager installed in the user terminal, the digital signature by using the private key encoding information when the information type of the private key is private key encoding information, and a step of generating, by the app, “signed verifiable presentation” by combining the digital signature with the verifiable presentation.

The method may further include steps of after the step of determining the information type of the private key, determining a user terminal that owns the original of the private key when the information type of the private key is a KeyID, and generating a digital signature by invoking a digital signature function of a secure element embedded in the user terminal by using the KeyID of the private key as an argument when the user terminal that owns the original of the private key is the user terminal. The step of generating the “signed verifiable presentation” may include invoking, by the app, the digital signature function of the secure element and generating the “signed verifiable presentation” by combining the generated digital signature with the verifiable presentation.

The method may further include a step of before the step of generating the verifiable presentation, receiving credential synchronization information including credential encoding information and private key information of credentials issued by the another terminal of the user and storing the credential synchronization information. The method may further include steps of after the step of determining the information type of the private key, determining a user terminal that owns the original of the private key when the information type of the private key is a KeyID, and requesting a digital signature for the verifiable presentation from the another terminal when the user terminal that owns the original of the private key is the another terminal and receiving the digital signature for the verifiable presentation from the another terminal. The step of generating the signed verifiable presentation may include generating the “signed verifiable presentation” by combining the digital signature received from the another terminal with the verifiable presentation.

Furthermore, according to an embodiment of the present disclosure, a method of registering and using, by a credential manager installed in a user terminal, credentials includes a step of receiving a request for the registration of credentials from an app installed in the user terminal, a step of registering the credentials when user authentication for the registration of the credentials is completed, a credential synchronization step of transmitting encoding information and private key information of the registered credentials to a credential synchronization server accessible to another terminal of the user, a step of selecting, by the app of the user terminal, credentials to be submitted to a service provider outside the user terminal and generating verifiable presentation by using the selected credentials, a step of requesting, by the app, a digital signature for the verifiable presentation from the credential manager installed in the user terminal, a step of determining, by the credential manager installed in the user terminal, information type of a private key of the credentials corresponding to the verifiable presentation, a step of generating, by the credential manager installed in the user terminal, a digital signature by using the private key encoding information when the information type of the private key is private key encoding information, and a step of generating, by the app, “signed verifiable presentation” by combining the digital signature with the verifiable presentation.

The credential synchronization step may include additionally transmitting, to the credential synchronization server, push information that enables a credential manager installed in the another terminal of the user to invoke the credential manager installed in the user terminal.

Furthermore, the credential synchronization step may include additionally transmitting, to the credential synchronization server, an identifier of the user terminal, a decentralized identifier (DID) of the credential manager, and ID information of an app of the user terminal whose access to the credentials has been blocked.

The method may further include steps of after the step of determining the information type of the private key, determining a user terminal that owns the original of the private key when the information type of the private key is a KeyID, and generating a digital signature by invoking a digital signature function of a secure element embedded in the user terminal by using the KeyID of the private key as an argument when the user terminal that owns the original of the private key is the user terminal. The step of generating the “signed verifiable presentation” may include invoking the digital signature function of the secure element and generating the “signed verifiable presentation” by combining the generated digital signature with the verifiable presentation.

The method may further include a step of before the step of generating the verifiable presentation, receiving credential synchronization information including credential encoding information and private key information of credentials issued by the another terminal of the user and storing the credential synchronization information. The method may further include steps of after the step of determining the information type of the private key, determining a user terminal that owns the original of the private key when the information type of the private key is a KeyID, and requesting a digital signature for the verifiable presentation from the another terminal when the user terminal that owns the original of the private key is the another terminal and receiving the digital signature for the verifiable presentation from the another terminal. The step of generating the signed verifiable presentation may include generating the “signed verifiable presentation” by combining the digital signature received from the another terminal with the verifiable presentation.

According to an embodiment of the present disclosure, the present disclosure has an effect in that a user can use credentials issued thereto in various user terminals without the redundant issuing of the credentials in a multi-decentralized identity management service environment.

Furthermore, according to an embodiment of the present disclosure, it is possible to safely manage credentials through the access control policy for an app and a terminal and the key management interface in which a private key is managed as a secure element.

The effects of the present disclosure are not limited to the above-mentioned effects, and other effects which are not mentioned herein will be clearly understood by those skilled in the art from the following descriptions.

### BRIEF DESCRIPTION OF THE DRAWINGS

FIG. 1 is a diagram illustrating a DID-based decentralized identity management service environment.

FIGS. 2A-2E are diagrams relating to a multi-decentralized identity management service.

FIG. 3 is a diagram illustrating a form in which a plurality of user terminals is used in a multi-decentralized identity management service environment.

FIG. 4 is a block diagram illustrating a construction of a user terminal and a credential manager according to an embodiment of the present disclosure.

FIG. 5 is a block diagram illustrating a construction of a credential management system and a credential management concept according to an embodiment of the present disclosure.

FIG. 6 is a flowchart for describing a method of registering credentials according to an embodiment of the present disclosure.

FIG. 7 is a flowchart for describing a method of using credentials according to a first embodiment of the present disclosure.

FIG. 8 is a flowchart for describing a method of using credentials according to a second embodiment of the present disclosure.

FIG. 9 is a flowchart for describing an embodiment of a method of generating verifiable presentation and performing a digital signature on the verifiable presentation according to the present disclosure.

FIG. 10 is a block diagram illustrating a computer system for implementing the method according to the embodiment of the present invention.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims. Terms used in this specification are used to describe embodiments and are not intended to limit the present disclosure. In this specification, an expression of the singular number also includes an expression of the plural number unless clearly defined otherwise in the context. The term “comprises” and/or “comprising” used in this specification does not exclude the presence or addition of one or more other components, steps, operations and/or devices in addition to mentioned components, steps, operations and/or elements.

In describing the present disclosure, a detailed description of a related known technology will be omitted if it is deemed to make the subject matter of the present disclosure unnecessarily vague.

Terms, such as a “first” and a “second”, may be used to describe various components, but the components are not restricted by the terms. The terms are used to only distinguish one element from the other element.

In describing the present disclosure, in order to facilitate general understanding of the present disclosure, the same reference numeral (or sign) is used for the same mean regardless of the reference numeral. If entities that have the same name are plural or if a plurality of components having the same name is included in different entities, respectively, the reference numerals of the entities or components are distinguished from one another by assigning dashes and serial numbers to the reference numerals. For example, if the number of user terminals 10 is two, the user terminals are distinguished from each other by using reference numerals like a “first user terminal 10-1” and a “second user terminal 10-2.” Even in a credential manager 200 that is included in the user terminal, credential managers are distinguished from each other like a “credential manager 200-1 that is included in the first user terminal 10-1” and a “credential manager 200-2 that is included in the second user terminal 10-2.” It should not be understood that although a dash and a serial number are added to the original reference numeral, a construction or function of an entity or component is made different because the dash and the serial number are used to merely distinguish between the entities or the components.

In this specification, a “user terminal” may be any one of various terminals, such as a mobile phone, a smartphone, a portable terminal, a mobile terminal, a foldable terminal, a personal digital assistant (PDA), a portable multimedia player (PMP) terminal, a telematics terminal, a navigation terminal, a personal computer, a laptop computer, a slate PC, a tablet PC, an ultrabook, a wearable device (e.g., including a watch type terminal (smartwatch), a glass type terminal (smart glass), and a head mounted display (HMD)), a Wibro terminal, an Internet protocol television (IPTV) terminal, smart TV, a terminal for digital broadcasting, an audio video navigation (AVN) terminal, an audio/video (AV) system, a flexible terminal, and a digital signage device, and the present disclosure is not limited to the example.

In this specification, a term “app” means application software (or an application) which may be installed in the “user terminal” and may operate therein. In this specification, an “app” is used for convenience sake. In this specification, an “app” may be an app that performs a function for being issued credentials by requesting the issuing of the credentials from a credential issuer, requesting the registration or inquiry of the credentials from a credential manager (e.g., an app that manages the credentials), and submitting the credentials to a service provider. For example, an “app” may be an app which may be issued a digital certificate, such as a digital mobile driving license.

In this specification, a term “synchronization” means that user terminals exchange pieces of required information directly or through a synchronization server in order to use credentials issued in a specific user terminal of a user in another terminal of the user if the same user has a plurality of user terminals. The required information (hereinafter referred to as “credential synchronization information”) may include information encoded from corresponding credentials, private key information of corresponding credentials, push information for invoking a credential manager (e.g., an app that manages credentials) that is included in each user terminal and access control information for a terminal/app.

Hereinafter, embodiments of the present disclosure are described in detail with reference to the accompanying drawings.

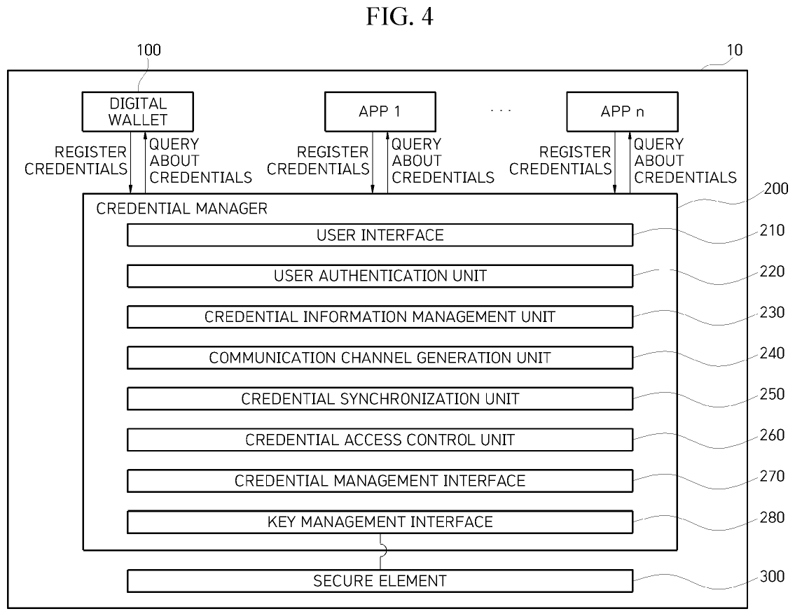

FIG. 4 is a block diagram illustrating a construction of a user terminal and a credential manager according to an embodiment of the present disclosure.

The credential manager 200 illustrated in FIG. 4 may safely integrate and manage credentials and conveniently inquire about and use the credentials, if necessary, in a multi-decentralized identity management service environment.

As illustrated in FIG. 4, the user terminal 10 includes the credential manager 200 and a secure element 300. Various apps (e.g., digital wallets) for registering or inquiring about credentials may be installed in the user terminal 10. The user terminal 10 may include various components, such as a memory, a processor, a wired/wireless communication unit, and a user interface, in addition to the components illustrated in the drawing. However, those skilled in the art (an ordinary skilled person) to which the present disclosure pertains will fully understand that these components are not written in the drawing in order to help understanding of the present disclosure. The credential manager 200 is installed in the user terminal 10, and manages credentials that are issued in the user terminal 10 or another terminal of a user. The credential manager 200 may be implemented in the form of software, such as an app, and may be implemented in the form of hardware having a DSP, an FPGA, an ASIC or a separate memory and a processor.

The digital wallet 100 requests the issuing of DID-based credentials for a user from a credential issuer 2. When the credential issuer 2 issues the credentials and responds to a request from the digital wallet 100, the digital wallet 100 requests the registration of the issued credentials from the credential manager 200.

The credential manager 200 registers the issued credentials through the digital wallet 100. The registration of the credentials by the credential manager 200 means that an app that has been installed in the user terminal 10 can inquire about and use the registered credentials.

The credential manager 200 performs user authentication for the registration of credentials, and confirms and stores credentials whose registration has been requested by the digital wallet 100. Furthermore, the credential manager 200 determines whether to perform synchronization processing based on a given setting value (“a setting value about whether to perform synchronization processing”, hereinafter referred to as a “synchronization processing setting value”). The synchronization processing setting value is a synchronization processing setting value of the credential manager 200 itself, and means setting contents of the credential manager 200 for whether to perform synchronization processing simultaneously with the registration of credentials. When the synchronization processing setting value is true, the credential manager 200 performs synchronization by transmitting, to a credential synchronization server 20, information (“credential synchronization information”) including credential encoding information, private key information of the credentials, etc. When the synchronization processing setting value is true, the credential manager 200 performs up to synchronization simultaneously when the digital wallet 100 registers the credentials. When the synchronization processing setting value is false, the corresponding credentials are registered with the credential manager 200 only.

Furthermore, when an app (any one of a digital wallet and an app 1 to an app n, hereinafter used as the same meaning) installed in the user terminal 10 makes a credential inquiry request, the credential manager 200 responds to the credential inquiry request. It is a prerequisite that the digital wallet and the app 1 to the app n are apps capable of requesting the registration or inquiry of credentials from the credential manager 200. If a registration app of credentials has generated verifiable presentation by using credentials to be submitted to an external service provider 3, when a digital signature for the verifiable presentation is requested, the credential manager 200 responds to the registration app by generating the digital signature through user authentication for the digital signature. When an app makes a digital signature request for credentials with which private key information necessary to use the credentials has not been synchronized, the credential manager 200 needs to remotely request the digital signature from a credential manager of another terminal of a user, which manages the private key of the corresponding credentials.

The credential manager 200 may be constructed to include a user interface 210, a user authentication unit 220, a credential information management unit 230, a communication channel generation unit 240, a credential synchronization unit 250, a credential access control unit 260, a credential management interface 270, and a key management interface 280.

The user interface 210 is a user interface for the inquiry, deletion, synchronization, access policy, and use history management of all credentials.

The user authentication unit 220 performs a function for registering and certificating a user who can access the credential manager 200. For example, the user authentication unit 220 certificates a user by using information, such as a face, a fingerprint, a PIN, a password, etc. of the user. All functions except a credential inquiry function, among credential management functions that are performed by the credential manager 200, require user authentication.

The credential information management unit 230 processes inquiry, update, deletion, and use history management functions for all credentials. Furthermore, the credential information management unit 230 manages the DID of a credential manager installed in another terminal of a user, which has been confirmed through credential synchronization. A DID list of the credential manager 200 is used in access control processing for the request of another credential manager.

Furthermore, the credential information management unit 230 stores, in the internal repository of the credential manager 200, information on credentials whose registration has been requested by an app that has been installed in the user terminal 10. Information (“credential registration information”) that is stored in the internal repository of the credential manager 200 when the credential information management unit 230 registers credentials may include the following information.

\textcircled{1} Information encoded from the credentials (“credential encoding information”)

\textcircled{2} Private key information of the credentials (i.e., information encoded from a private key (“private key encoding information”) or a KeyID for private key inquiry, password type information)

\textcircled{3} Access control information: the device ID of a user terminal that owns the original of a private key (if private key information is a KeyID), the ID of an app that has generated the credentials, the device ID of a user terminal in which the credential manager 200 has been installed, the ID of the credential manager 200 (if the credential manager is an app, the app ID of the credential manager), the DID of the credential manager 200, the ID of an app whose access to the credentials is blocked (e.g., the ID of the app is hash information of an APK signature certificate)

Among the contents relating to \textcircled{2} private key information of the credentials, the KeyID is for inquiring about the private key that has been stored in a secure element. In this case, the secure element in which the private key has been stored may be the secure element 300 of the user terminal 10, and may be a secure element of another terminal of a user. Furthermore, the “password type information” is information that is necessary when a digital signature is performed by using a private key. The “password type information” is an algorithm type that is generally used in a common encryption field, and may include “PS256”, “ES384”, “ES256K”, “EdDSA”, etc., for example.

The “user terminal that owns the original of the private key” among the contents relating to \textcircled{3} access control information may be the user terminal 10, and may be another terminal of a user.

Furthermore, the credential information management unit 230 stores, in the internal repository of the credential manager 200, credential synchronization information on the credentials of another terminal in the credential synchronization unit 250. Detailed contents of the credential synchronization information are described later in relation to the credential synchronization unit 250.

Furthermore, when an app that has been installed in the user terminal 10 or a credential manager that is included in another terminal of a user receives a request for a digital signature (or a digital signature document) for verifiable presentation, the credential information management unit 230 confirms the type of private key information of credentials, which correspond to the verifiable presentation, and the device ID of the user terminal that owns the original of a private key, and performs processing so that the digital signature is performed on the credentials based on a result of the confirmation. For reference, the credentials corresponding to the verifiable presentation may be plural. When the type of private key information of the credentials is “private key encoding information (i.e., information encoded from a private key)”, the credential information management unit 230 generates the digital signature by using private key encoding information of the corresponding private key in accordance with a password type. Furthermore, when the type of private key information of the credentials is a KeyID, the credential information management unit 230 confirms the device ID of a user terminal that owns the original of a private key.

\textcircled{1} When the device ID is the device ID of the user terminal 10, the credential information management unit 230 transmits the KeyID of a private key of corresponding credentials to the key management interface 280. The key management interface 280 invokes a digital signature function of the secure element 300 so that the secure element 300 generates a digital signature by using the private key corresponding to the KeyID and returns the generated digital signature. The digital signature that is returned from the secure element 300 to the key management interface 280 is transferred to the credential information management unit 230.

\textcircled{2} When the device ID is the device ID of another terminal of a user, the credential information management unit 230 requests a digital signature (or digital signature document) from (a credential information management unit of) a credential manager that is included in another terminal of the user. That is, the credential information management unit 230 remotely requests the digital signature by using push information of the credential manager of the another terminal of the user that owns the original of a corresponding private key. For example, Firebase cloud messaging information of Android, etc. may be used as the push information.

In addition, when a credential manager that is included in another terminal of a user requests a digital signature (or digital signature document) for verifiable presentation, the credential information management unit 230 determines whether to provide the digital signature based on access control contents for a credential manager that is included in the another terminal.

The communication channel generation unit 240 generates a safe communication channel. The “safe communication channel generation” means that two entities generate a safe encryption communication channel by exchanging encryption keys based on public key information that is identified as a DID. The “two entities” may be any one of cases “the user terminal 10 and the credential issuer 2”, “the user terminal 10 and the service provider 3”, “the user terminal 10 and another terminal of a user”, and “the user terminal 10 and the credential synchronization server 20.”

The credential synchronization unit 250 sets (“synchronization processing setting value”) whether to perform synchronization processing on all credentials, and processes credential synchronization. The synchronization processing setting value means setting contents about whether to perform synchronization processing by the credential synchronization unit 250 simultaneously with the registration of credentials. When the synchronization processing setting value is true, the credential synchronization unit 250 performs synchronization by transmitting, to the credential synchronization server 20, information (“credential synchronization information”) including credential encoding information, private key information of the credentials, etc. When the synchronization processing setting value is true, the credential synchronization unit 250 performs up to synchronization along with the credential information management unit 230 with respect to a credential registration request from the digital wallet 100. When the synchronization processing setting value is false, corresponding credentials are registered with the credential manager 200 only.

The information (“credential synchronization information”) that is transmitted from the credential synchronization unit 250 to the credential synchronization server 20 when the credential synchronization unit 250 registers (or synchronizes) the credentials includes the following information \textcircled{1}, \textcircled{2}, \textcircled{3}, and \textcircled{4}.

\textcircled{1} Credential encoding information (information encoded from the credentials) registered with the credential manager 200 by the digital wallet 100 (or another app)

\textcircled{2} Private key information of the credentials: information encoded from a private key or a KeyID for private key inquiry, and password type information

\textcircled{3} Push information (e.g., Firebase cloud messaging information of Android) of the credential manager 200 based on which a credential manager that has been installed in another terminal of a user may invoke the credential manager 200 of the user terminal 10

\textcircled{4} Access control information: the device ID (when private key information is a KeyID) of a user terminal that owns the original of a private key, the ID of an app that has generated the credentials, the device ID of a user terminal in which the credential manager 200 has been installed, the ID of the credential manager 200 (i.e., the app ID of a credential manager when the credential manager is an app), the DID of the credential manager 200, the ID of an app (e.g., the ID of the app is hash information of an APK signature certificate) whose access to the credentials is blocked

In this case, it is a prerequisite that the device ID of the user terminal, the ID of the credential manager 200-1, and the DID of the credential manager 200-1, among \textcircled{4} access control information, have been generated by the credential manager 200-1 when the credential manager 200-1 is registered with the credential synchronization server 20 and have been transferred to the credential synchronization server 20.

Furthermore, the credential synchronization unit 250 receives, from the credential synchronization server 20, credential synchronization information on credentials issued in another terminal of a user, and transfers the credential synchronization information to the credential information management unit 230. The credential information management unit 230 stores the credential synchronization information in the internal repository. The credential synchronization information may be used when the credential information management unit 230 performs a digital signature or requests a digital signature from the credential information management unit of a credential manager of another terminal.

According to another embodiment of the present disclosure, the credential synchronization unit 250 may transmit or receive the aforementioned credential synchronization information by directly communicating with another terminal of a user.

The credential access control unit 260 sets and manages an access policy for all credentials. The access policy includes a policy for controlling an app installed in the user terminal 10 to access credentials, and also includes a policy for controlling a credential manager (i.e., access control between credential managers) or an app that has been installed in another terminal of a user to access credentials. Since all apps installed in the user terminal 10 have unique identifiers, the credential access control unit 260 may control access by using information of the identifiers. An access control type may be divided into two types, that is, a local type (an app within the user terminal 10) and a remote type (a credential manager of another terminal). The ID of an app is used for local access control. The DID of a credential manager and the ID (i.e., the ID of a credential manager app if credential management is implemented in the form of an app) of a corresponding credential manager are used for remote access control.

The credential management interface 270 is a credential management interface through which an app (the app means any one of a digital wallet and an app 1 to an app n as described above, hereinafter the same) may safely integrate and manage credentials by using the credential manager 200 and may inquire about and use the credentials, if necessary. The credential management interface 270 provides key generation, key deletion, digital signature, credential registration, inquiry, update, and deletion interfaces.

The key management interface 280 invokes a function for generating and deleting a private key and performing a digital signature by using the secure element 300 that is provided for each user terminal. That is, the key management interface 280 is an interface with the API of the secure element 300 that is provided by the user terminal 10. Since the standard of an encryption algorithm provided by the secure element 300 is different for each device, the key management interface 280 is designed in the form of only a common encryption algorithm into which an encryption algorithm standard which may be provided in common has been incorporated. The reason why the key management interface 280 is designed as described above is for enabling the key management interface 280 to smoothly operate even in different devices (e.g., Android and iPhone).

The secure element 300 is a key management module that is provided by a terminal itself, and it generates a private key associated with credentials in an independent secure area and stores/manages the private key without outside exposure. The secure element 300 generates a digital signature using a private key if necessary (e.g., when a digital signature function is invoked through the key management interface 280), and returns the digital signature to the credential information management unit 230 through the key management interface 280.

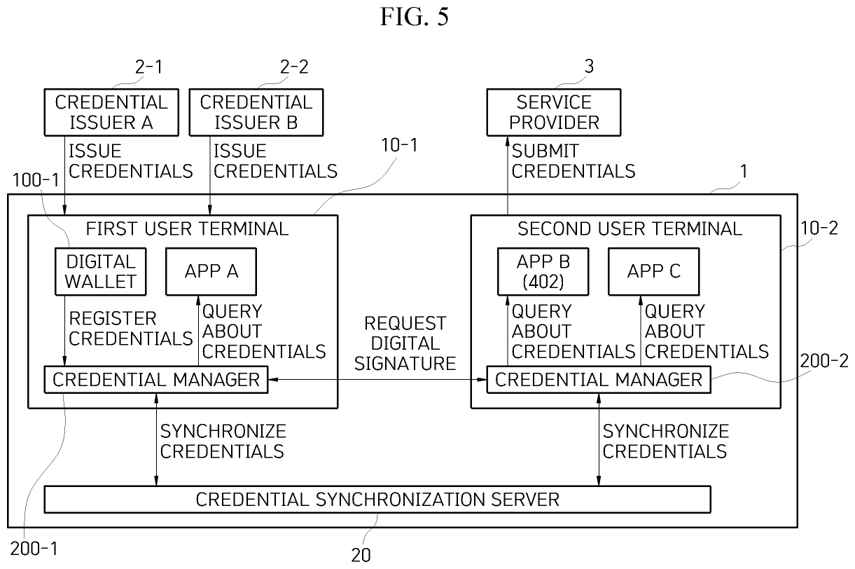

FIG. 5 is a block diagram illustrating a construction of a credential management system and a credential management concept according to an embodiment of the present disclosure. That is, FIG. 5 illustrates a scenario that manages credentials by applying a credential management method according to the present disclosure.

A credential management system 1 according to an embodiment of the present disclosure includes the first user terminal 10-1, the second user terminal 10-2, and the credential synchronization server 20. The first user terminal 10-1 is issued credentials from a credential issuer A 2-1 and a credential issuer B 2-2. The digital wallet 100-1 of the first user terminal 10-1 registers the issued credentials with a credential manager 200-1. An app A of the first user terminal 10-1 may inquire about the registered credentials. The credential manager 200-1 of the first user terminal 10-1 may share credential synchronization information (e.g., information encoded from the credentials or private key information) with the second user terminal 10-2, that is, another terminal of a user, through the credential synchronization server 20. If the credentials have been synchronized between the credential manager 200-1 of the first user terminal 10-1 and the credential manager 200-2 of the second user terminal 10-2, the credential manager 200-1 and the credential manager 200-2 may mutually request digital signatures. An app B or app C of the second user terminal 10-2 may inquire about the credentials at the credential manager 200-2. If credentials that need to be submitted to the service provider 3 are the credentials issued to the first user terminal 10-1 and only the private key KeyID of the first user terminal 10-1 has been shared with the second user terminal 10-2, the credential manager 200-2 remotely requests the digital signature from the credential manager 200-1 of the first user terminal 10-1. The app B or the app C of the second user terminal 10-2 generates verifiable presentation (e.g., information derived from a plurality of verifiable credentials) by using the digital signature.

The second user terminal 10-2 submits the verifiable presentation to the service provider 3 in order to receive a service from the service provider 3.

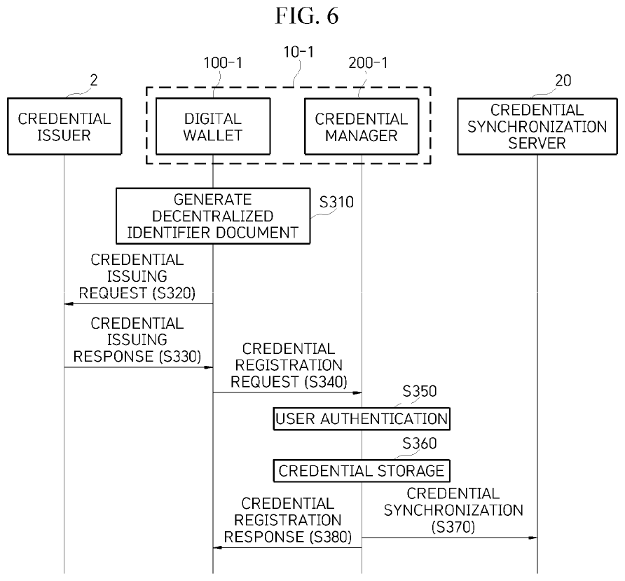

FIG. 6 is a flowchart for describing a method of registering credentials according to an embodiment of the present disclosure. FIG. 6 illustrates a method of a user who uses two terminals as in FIG. 5 registering, with the credential manager 200-1, credentials issued by the digital wallet 100-1 of the first user terminal 10-1 and synchronizing the credentials through the credential synchronization server 20. The method of registering and synchronizing the credentials includes step S310 to step S380.

Step S310 is a decentralized identifier document generation step. The user generates the DID of the user for the issuing of credentials and a decentralized identifier document through the digital wallet 100-1. Most of DIDs are generated based on public key information. The digital wallet 100-1 may generate the public key information through the key management interface 280 of the credential manager 200-1. If a public key is generated through the credential manager 200-1, the credential manager 200-1 generates a pair of public keys by using the secure element 300 that is provided by a terminal of the user. The credential manager 200-1 stores a private key of the pair of generated public keys in a secure element 300-1 and returns only public key information to the digital wallet 100-1. Accordingly, private key information that is associated with the DID is stored and managed in the secure element 300-1 of the first user terminal 10-1. Accordingly, the credentials can be safely used without being exposed to the outside.

Step S320 is a credential issuing request step. In response to an input from the user, the digital wallet 100-1 requests, from the credential issuer 2, the issuing of the credentials based on the DID of the user.

Step S330 is a credential issuing response step. The credential issuer 2 issues the credentials based on the DID of the user to the digital wallet 100-1, and responds to the issuing request of the digital wallet 100-1. The user may check the issued credentials based on the results of the credential issue response.

Step S340 is a credential registration request step. The digital wallet 100-1 may register the issued credentials with the credential manager 200-1 automatically or in response to an input from the user. To register the credentials with the credential manager 200-1 means that another app that has been installed in the user terminal can inquire about and use the registered credentials. The digital wallet 100-1 may register the credentials with a credential information management unit 230-1 of the credential manager 200-1 through a credential management interface 270-1. When the digital wallet 100-1 registers the credentials with the credential information management unit 230-1, information that is transmitted from the digital wallet 100-1 to the credential management interface 270-1 includes the following information \textcircled{1}, \textcircled{2}, and \textcircled{3}.

\textcircled{1} Information encoded from the credentials

\textcircled{2} Private key information of the credentials (i.e., information encoded from a private key (private key encoding information), a KeyID for private key inquiry, or password type information)

\textcircled{3} Access control information: the ID of an app that has generated the credentials (the ID of the app is hash information of an APK signature certificate)

For reference, \textcircled{2} the private key information of the credentials includes i) the private key encoding information and ii) the KeyID. i) The private key encoding information corresponds to a method of an app of a user terminal directly generating a pair of public keys in a software way and managing all of private keys and public keys. ii) The KeyID corresponds to a method of the credential manager 200 generating a private key by using the API of the secure element 300 that is provided by the user terminal 10 when an app requests the credential manager 200 to generate the private key by using the key management interface 280 of the credential manager 200. In this case, the secure element 300 generates the pair of public keys through a hardware module, stores and manages the private key only within hardware thereof, and returns only public key information corresponding to the private key. Furthermore, when the secure element 300 returns the public key, the secure element 300 returns the KeyID for searching for a private key corresponding to the public key along with the public key.

Step S350 is a user authentication step. The credential manager 200-1 performs user authentication for the registration of the credentials.

Step S360 is a credential storage step. The credential manager 200-1 confirms and stores the credentials whose registration has been requested by the digital wallet 100-1. Specifically, the credential information management unit 230-1 stores, in the internal repository of the credential manager 200, information (“credential registration information”) on the credentials whose registration has been requested by the digital wallet 100-1. The credential registration information includes credential encoding information, etc. Detailed contents of the credential registration information have been described above with reference to FIG. 4.

Step S370 is a credential synchronization step. The credential manager 200-1 confirms whether synchronization processing has been performed on the registered credentials according to a synchronization policy, and performs the synchronization. Information (“credential synchronization information”) that is transmitted from the credential manager 200-1 to the credential synchronization server 20 when the credential manager 200-1 registers (synchronizes) the credentials includes the following information \textcircled{1}, \textcircled{2}, \textcircled{3}, and \textcircled{4}.

\textcircled{1} Credential encoding information (i.e., information encoded from the credentials) registered with the credential manager 200-1 by the digital wallet 100-1 (or another app)

\textcircled{2} Private key information of the credentials (i.e., information encoded from a private key, a KeyID for private key inquiry, or password type information)

\textcircled{3} Push information (e.g., Firebase cloud messaging information of Android, etc.) of the credential manager 200-1 based on which the credential manager 200-2 that has been installed in another terminal of the user may invoke the credential manager 200-1

\textcircled{4} Access control information: the device ID of a user terminal (if private key information is a KeyID) that owns the original of a private key, the ID of an app that has generated the credentials, the device ID of a user terminal in which the credential manager 200-1 has been installed, the ID of the credential manager 200-1 (i.e., the app ID of a credential manager if the credential manager is an app), the DID of the credential manager 200-1, or the ID of an app whose access to the credentials is blocked

In this case, it is a prerequisite that the device ID of the user terminal, the ID of the credential manager 200-1, and the DID of the credential manager 200-1, among the \textcircled{4} access control information, have been generated by the credential manager 200-1 and transmitted from the credential manager 200-1 to the credential synchronization server 20 when the credential manager 200-1 is registered with the credential synchronization server 20.

Step S380 is a credential registration response step. The credential manager 200-1 transmits a response to the credential registration request to the digital wallet 100-1. The user checks the results of the response to the credential registration request through the digital wallet 100-1.

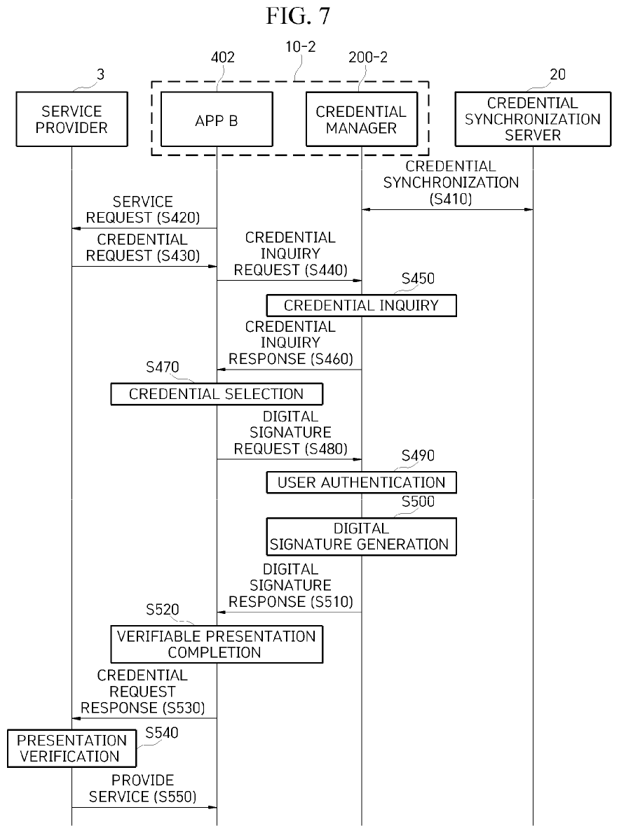

FIG. 7 is a flowchart for describing a method of using credentials according to a first embodiment of the present disclosure. FIG. 7 illustrates a method of inquiring about credentials for which even a private key (i.e., information encoded from the private key) necessary to use the credentials has been fully synchronized at the app B 402 of the second user terminal 10-2 and using the credentials. The method may be applied to a case in which information encoded from a private key has been synchronized because the private key is not generated by a secure element. The method of synchronizing and using the credentials according to the first embodiment includes step S410 to step S550.

Step S410 is a credential synchronization step. The credential manager 200-2 that has been installed in the second user terminal 10-2 previously completes credential synchronization processing through communication with the credential synchronization server 20 prior to the use of the credentials. The credential manager 200-2 receives “credential synchronization information” from the credential synchronization server 20. Detailed contents of the “credential synchronization information” have been described above with reference to FIG. 4.

Step S420 is a service request step. The app B 402 requests a service from the service provider 3 in response to an input from a user.

Step S430 is a credential request step. The service provider 3 request, from the app B 402 of the second user terminal 10-2, the credentials necessary to provide the service. That is, the service provider 3 requests the app B 402 of the second user terminal 10-2 to submit the credentials necessary to provide the service.

Step S440 is a credential inquiry request step. The app B 402 requests the credential manager 200-2 to inquire about the credentials stored in the credential manager 200-2 by using the credential management interface 270.

Step S450 is a credential inquiry step. The credential manager 200-2 inquires about the stored credentials. The credential manager 200-2 may set credentials whose sharing with another app has been blocked through an access policy that is managed by the credential access control unit 260-2. The credential manager 200-2 checks access control over the credentials of the app B 402 according to the access policy.

Step S460 is a credential inquiry response step. The credential manager 200-2 transmits the results of the inquiry of the stored credentials to the app B 402 as a response to the credential inquiry request. The user may check the credentials that have been inquired about by the credential manager 200-2 through the app B 402.

Step S470 is a credential selection step. The app B 402 selects the credentials to be submitted to the service provider 3 automatically or in response to an input from the user.

Step S480 is a digital signature request step. The app B 402 generates verifiable presentation by using the credentials to be submitted to the service provider 3, and request a digital signature for the verifiable presentation from the credential manager 200-2.

Step S490 is a user authentication step. The credential manager 200-2 performs user authentication for the digital signature.

Step S500 is a digital signature generation step. First, the credential manager 200-2 confirms the type of private key information of the credentials that will be electronically signed. If the type of private key information is a KeyID, the credential manager 200-2 determines a method of generating the digital signature and whether to request the digital signature by additionally confirming the device ID of a user terminal that owns the original of a private key. In the present embodiment, since the private key type is a private key encoding information (i.e., information encoded from a private key) form, the credential manager 200-2 generates the digital signature by using the private key encoding information in accordance with a password type. In this case, the credential manager 200-2 may determine whether the app B 402 is accessible by confirming the access policy for the corresponding credentials. Detailed contents of the digital signature have been described above with reference to FIG. 4.

Step S510 is a digital signature response step. The credential manager 200-2 transmits a response to the digital signature request to the app B 402.

Step S520 is a verifiable presentation completion step. The app B 402 confirms the digital signature, and completes the verifiable presentation to be submitted to the service provider 3 by using the confirmed digital signature. That is, the app B 402 completes the signed verifiable presentation by combining the digital signature with contents that will be electronically signed.

Step S530 is a credential request response step. The app B 402 responds to the credential request of the service provider 3 by transmitting the verifiable presentation to the service provider 3.

Step S540 is a presentation verification step. The service provider 3 verifies the verifiable presentation, and provides the service when the verifiable presentation complies with the credential request as a result of the verification (S550).

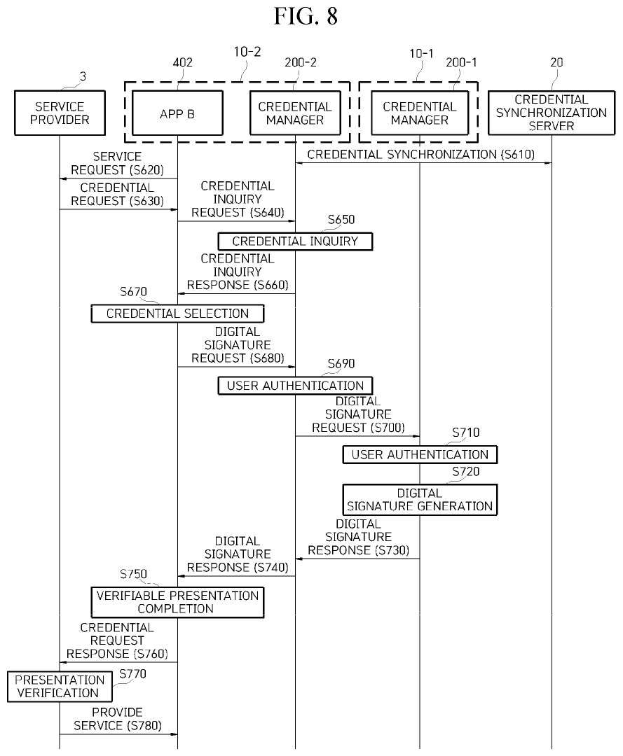

FIG. 8 is a flowchart for describing a method of using credentials according to a second embodiment of the present disclosure. FIG. 8 illustrates a method of the app B 402 of the second user terminal 10-2 inquiring about credentials with which private key encoding information necessary to use the credentials has not been synchronized and using the credentials. The method may be applied to a case in which a private key is generated by the secure element. In this case, the credential manager 200-2 of the second user terminal 10-2 needs to remotely request a digital signature from the credential manager 200-1 of the first user terminal 10-1 that manages the private key of the credentials. In this case, the credential manager 200-1 determines whether to provide the digital signature based on the contents of access control over a requester (i.e., the credential manager 200-2).

The method of synchronizing and using credentials according to the second embodiment includes Step S610 to step S780.

Step S610 is a credential synchronization step. The credential manager 200-2 that has been installed in the second user terminal 10-2 previously completes credential synchronization processing through communication with the credential synchronization server 20 prior to the use of the credentials. The credential manager 200-2 receives “credential synchronization information” from the credential synchronization server 20. Detailed contents of the “credential synchronization information” have been described above with reference to FIG. 4.

Step S620 is a service request step. The app B 402 requests a service from the service provider 3 in response to an input from a user.

Step S630 is a credential request step. The service provider 3 requests, from the app B 402 of the second user terminal 10-2, the credentials necessary to provide the service.

Step S640 is a credential inquiry request step. The app B 402 requests the credential manager 200-2 to inquire about the credentials stored in the credential manager 200-2 by using a credential management interface 270-2.

Step S650 is a credential inquiry step. The credential manager 200-2 inquires about the stored credentials. The credential manager 200-2 may set credentials whose sharing with another app has been blocked according to an access policy that is managed by the credential access control unit 260-2. The credential manager 200-2 checks access control over the credentials of the app B 402 according to the access policy.

Step S660 is a credential inquiry response step. The credential manager 200-2 transmits the results of the inquiry of the stored credentials to the app B 402 as a response to the credential inquiry request. The user may check the credentials that have been inquired about by the credential manager 200-2 through the app B 402.

Step S670 is a credential selection step. The app B 402 selects the credentials to be submitted to the service provider 3 automatically or in response to an input from the user.

Step S680 is a digital signature request step. The app B 402 generates verifiable presentation by using the credentials to be submitted to the service provider 3, and requests a digital signature for the verifiable presentation from the credential manager 200-2. The structure of the verifiable presentation may be divided into contents that will be electronically signed and the digital signature. In this step, the app B 402 generates the contents that will be electronically signed.

Step S690 is a user authentication step. The credential manager 200-2 performs user authentication for the digital signature.

Step S700 is a digital signature request step (or a digital signature document generation step). First, the credential manager 200-2 confirms the type of private key information of the credentials that will be electronically signed. When the type of private key information is a KeyID, the credential manager 200-2 determines a method of generating the digital signature and whether to make a digital signature request by additionally confirming the device ID of a user terminal that owns the original of a private key. In the present embodiment, since the private key type is a KeyID form and the user terminal that owns the original of the private key is the first user terminal 10-1, the credential manager 200-2 requests the digital signature from the first user terminal 10-1 that owns the original of the private key. That is, the credential manager 200-2 remotely requests the digital signature by using push information of the credential manager 200-1 of the first user terminal 10-1 that owns the original of the private key. For example, Firebase cloud messaging information of Android, etc. may be used as the push information. Detailed contents of the digital signature have been described above with reference to FIG. 4.

Step S710 is a user authentication step. The credential manager 200-1 performs user authentication for the digital signature.

Step S720 is a digital signature generation step. The credential manager 200-1 checks whether the app B 402 is accessible by checking the access policy for the credentials, and generates the digital signature.

Step S730 is a digital signature response step. The credential manager 200-1 transmits, to the credential manager 200-2, a response to the digital signature request. That is, the digital signature is transmitted to the credential manager 200-2.

Step S740 is a digital signature response step. The credential manager 200-2 transmits the response results of the digital signature of the credential manager 200-1 to the app B 402.

Step S750 is a verifiable presentation completion step. The app B 402 checks the digital signature, and completes verifiable presentation to be submitted to the service provider 3 by using the checked digital signature. That is, the app B 402 completes the signed verifiable presentation by combining the digital signature with contents that will be electronically signed.

Step S760 is a credential request response step. The app B 402 responds to the credential request of the service provider 3 by transmitting the verifiable presentation to the service provider 3.

Step S770 is a presentation verification step. The service provider 3 verifies the verifiable presentation, and provides the service when the verifiable presentation complies with the credential request as the results of the verification (S780).

The first embodiment described with reference to FIG. 7 is a case in which credential managers have been synchronized by using private key encoding information. In this case, different terminals of a user may use credentials that are generated based on a corresponding private key. Accordingly, the first embodiment has an advantage in that a digital signature can be conveniently performed based on a private key. In contrast, the second embodiment described with reference to FIG. 8 is a case in which credential managers are synchronized by using a private key ID. The second embodiment is inconvenient because a digital signature request (PUSH) has to be made from a user terminal in which the private key of credentials has been stored in order to use the credentials, but has an advantage in terms of security because a private key is not exposed to the outside of a secure element.

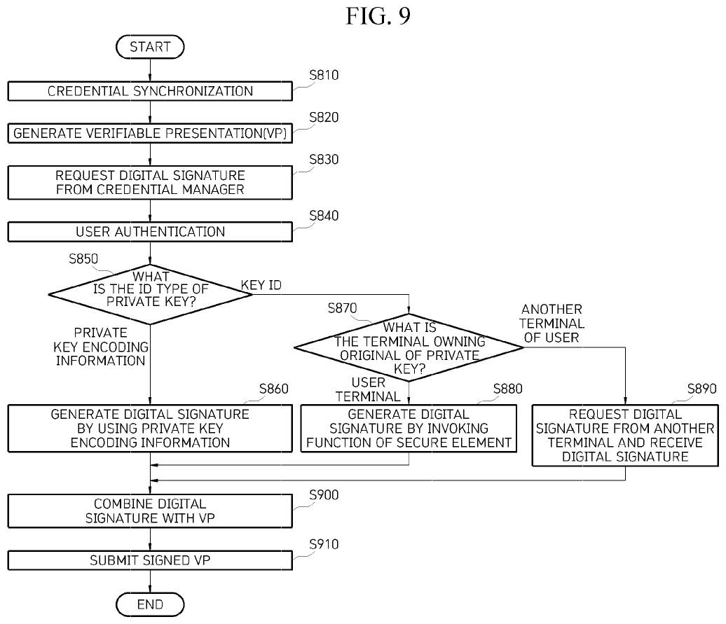

FIG. 9 is a flowchart for describing an embodiment of a method of generating verifiable presentation and performing a digital signature on the verifiable presentation according to the present disclosure.

According to an embodiment of the present disclosure, the method of generating verifiable presentation and a digital signature for the verifiable presentation through the credential manager may be constructed to include step S810 to step S900, and may further include step S910. Step S860, step S880, and step S890 may simultaneously occur, and step S890 may be executed with respect to a plurality of terminals different from a user terminal. For example, if verifiable presentation is generated as three credentials generated in different terminals (or devices), a digital signature for the same verifiable presentation contents is requested from each of the three terminals. Verifiable presentation that include all of the three digital signatures that have been received as responses to the requests becomes the final verifiable presentation.

Step S810 is a credential synchronization step. The credential manager 200 that has been installed in the user terminal 10 previously completes credential synchronization processing through communication with the credential synchronization server 20 prior to the use of credentials. The credential manager 200 receives “credential synchronization information” from the credential synchronization server 20, and stores the “credential synchronization information” in the internal repository thereof. The credential synchronization information includes credential encoding information relating to the credentials issued by another terminal 10-3 of a user, private key information, etc. The private key information and a password type that are included in the credential synchronization information may be used when a digital signature needs to be performed on the verifiable presentation. Detailed contents of the “credential synchronization information” have been described above with reference to FIG. 4.

Step S820 is a verifiable presentation VP generation step. An app A 401 that has been installed in the user terminal requests a service from the service provider 3. The service provider 3 requests, from the app A 401, the credentials necessary to provide the service. The app A 401 requests the credential manager 200 to inquire about the credentials that have been stored in the internal repository of the credential manager 200 by using the credential management interface 270. The credential manager 200 inquires about the stored credentials. The credential manager 200 may set credentials whose sharing with another app has been blocked through an access policy that is managed by the credential access control unit 260. The credential manager 200 checks access control over the credentials of the app A 401 according to the access policy. If the app A 401 is an app, that is, an access control target, as a result of the check, the credential manager 200 transmits a credential inquiry-impossible response to the app A 401. If the app A 401 can access the credentials necessary to provide the service, the credential manager 200 transmits the results of the credential inquiry to the app A 401 as a response to the inquiry request. The user may check the credentials that have been inquired about by the credential manager 200 through the app A 401.

The app A 401 selects the credentials to be submitted to the service provider 3 based on the results of the credential inquiry, and generates verifiable presentation VP. That is, the app A 401 generates the verifiable presentation by using the credentials that have been inquired about. In this case, the app A 401 selects the credentials to be submitted to the service provider 3 automatically or in response to an input from the user. The structure of the verifiable presentation may be divided into contents that will be electronically signed and the digital signature. In this step, the app A 401 generates the contents that will be electronically signed.

Step S830 is a step of requesting a digital signature from the credential manager. The app A 401 requests the digital signature for the verifiable presentation from the credential manager 200.

Step S840 is a user authentication step. The credential manager 200 performs user authentication for the digital signature.

Step S850 is a step of determining a private key ID type. The credential manager 200 confirms the type of private key information of the credentials corresponding to the verifiable presentation that will be electronically signed. The credential manager 200 proceeds to step S860 if the type of private key information is private key encoding information, and proceeds to step S870 if the type of private key information is KeyID information. Step S860 and step S870 may be simultaneously performed. For example, if credentials corresponding to verifiable presentation are three credentials C1, C2, and C3, the type of private key information of the credential C1 is private key encoding information, and the type of private key information of the credentials C2 and C3 is a KeyID, step S860 is performed on the credentials C1, and step S870 is performed on the credentials C2 and C3.

Step S860 is a step of generating a digital signature by using the private key encoding information. The credential information management unit 230 of the credential manager 200 generates a digital signature by using private key encoding information of a corresponding private key in accordance with the password type.

Step S870 is a step of determining a terminal that owns the original of the private key. In order to determine a terminal that owns the original of the private key, the credential manager 200 confirms the device ID of a user terminal that owns the original of the private key. When the terminal that owns the original of the private key is the user terminal, the credential manager 200 proceeds to step S880. When the terminal that owns the original of the private key is another terminal of the user, the credential manager 200 proceeds to step S890. Step S880 and step S890 may be simultaneously performed. For example, if the type of private key information corresponding to verifiable presentation includes credentials C2 and C3, that is, KeyIDs, a terminal that owns the original of the private key of the credentials C2 is the user terminal, and a terminal that owns the original of the private key of the credentials C3 is another terminal of the user, step S880 is performed on the credentials C2, and step S890 is performed on the credentials C3.

Step S880 is a step of generating a digital signature by invoking the digital signature function of the secure element 300. The credential information management unit 230 transmits the KeyID of the private key of corresponding credentials to the key management interface 280. The key management interface 280 invokes the digital signature function of the secure element 300 so that the secure element 300 generates the digital signature by using the private key corresponding to the KeyID and returns the generated digital signature. The digital signature that has been returned from the secure element 300 to the key management interface 280 is transferred to the credential information management unit 230.

Step S890 is a step of requesting the digital signature from another terminal of the user and receiving the digital signature. The credential manager 200 requests the digital signature from the another terminal 10-3 of the user that owns the original of the corresponding private key. That is, the credential manager 200 remotely requests the digital signature by using push information of a credential manager 200-3 of the terminal 10-3 that owns the original of the corresponding private key. For example, Firebase cloud messaging information of Android, etc. may be used as the push information. The credential manager 200-3 of the another terminal 10-3 of the user checks whether the credential manager 200 is accessible according to an access policy of the credential manager 200. If the credential manager 200 is accessible, the credential manager 200-3 generates the digital signature and transmits the digital signature to the credential manager 200. The digital signature transmitted by the credential manager 200-3 is transferred to the credential information management unit 230. Detailed contents of the digital signature have been described above with reference to FIG. 4.

Step S900 is a step of combining the digital signature with the verifiable presentation VP. The credential manager 200 transfers the digital signature to the app A 401. The verifiable presentation VP includes contents (i.e., information derived from the credentials) that will be electronically signed and the digital signature. The app A 401 confirms the digital signature and combines the digital signature with the verifiable presentation VP. That is, the app A 401 generates signed verifiable presentation by combining the digital signature with the contents that will be electronically signed.

Step S910 is a step of submitting the signed verifiable presentation to the service provider. The app A 401 responds to the credential request of the service provider 3 by transmitting the signed verifiable presentation to the service provider 3 as described above.

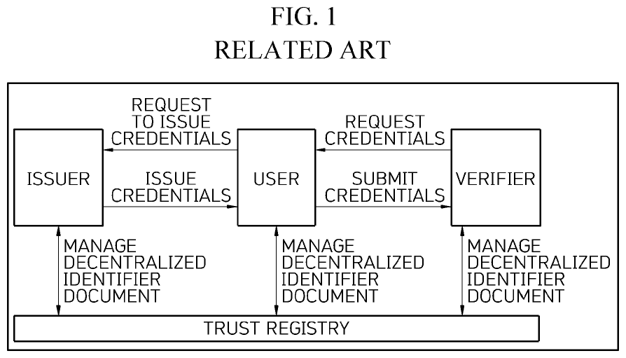

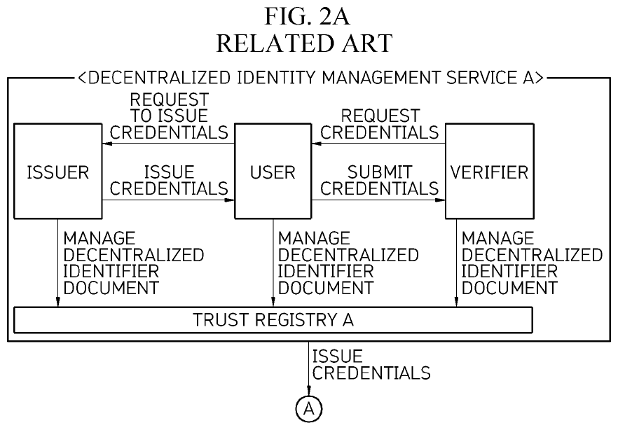

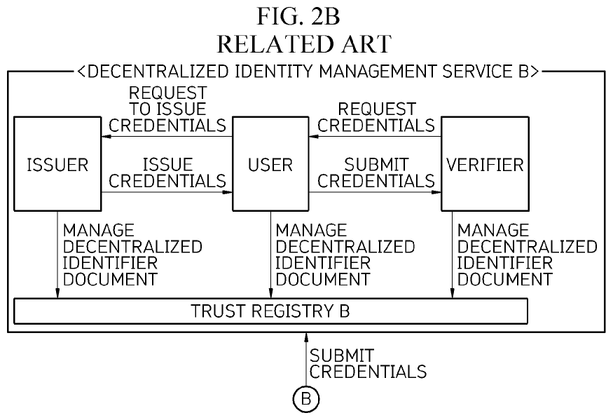

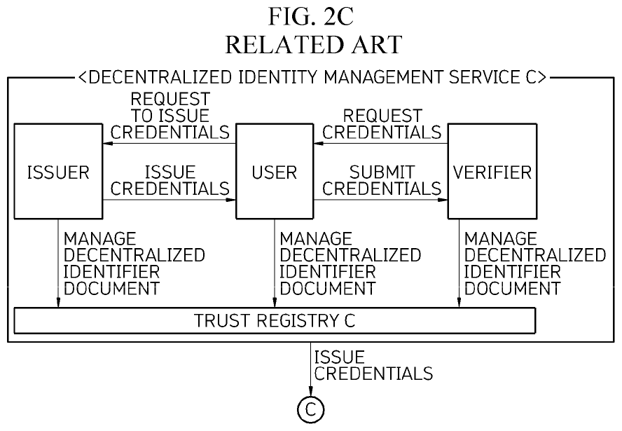

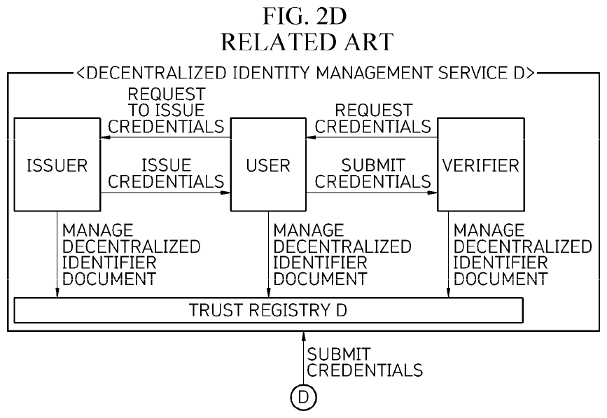

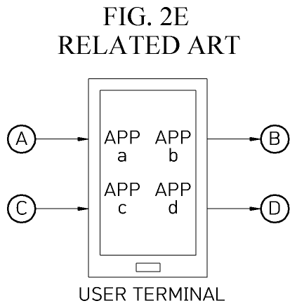

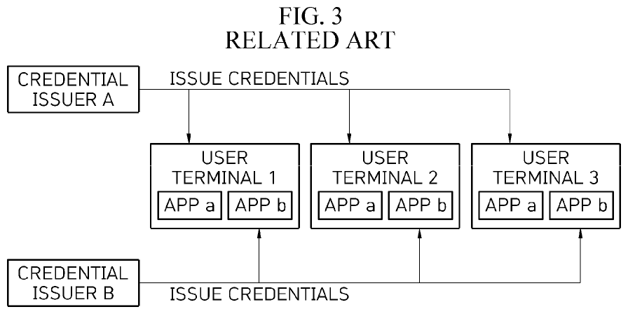

In the description given with reference to FIGS. 6 to 9, each step may be further divided into additional steps or the steps may be combined into smaller steps depending on an implementation example of the present disclosure. Furthermore, some steps may be omitted if necessary, and the sequence of the steps may be changed. Furthermore, although some contents are omitted, the contents of FIGS. 1 to 5 may be applied to the contents of FIGS. 6 to 9. Furthermore, the contents of FIGS. 6 to 9 may be applied to the contents of FIGS. 1 to 5. Furthermore, the contents of FIGS. 6 to 8 may be applied to the contents of FIG. 9, and the contents of FIG. 9 may be applied to the contents of FIGS. 6 to 8.

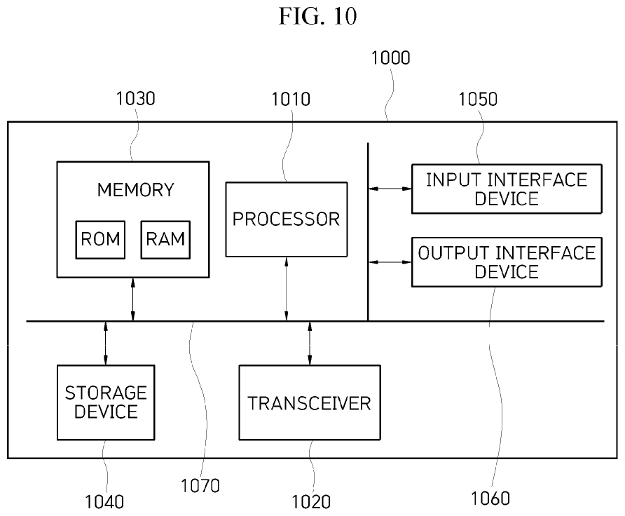

FIG. 10 is a block diagram illustrating a computer system for implementing the method according to the embodiment of the present invention.

Referring to FIG. 10, a computer system 1000 may include at least one of a processor 1010, a memory 1030, an input interface device 1050, an output interface device 1060, and a storage device 1040 which communicate via a bus 1070. The computer system 1000 may further include a transceiver 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random-access memory (RAM). In the embodiment of the present invention, the memory may be positioned inside or outside the processor, and the memory may be connected to the processor through various known units. The memory may include various types of volatile or non-volatile storage media. For example, the memory may include a ROM or a RAM.

Therefore, the embodiment of the present invention may be implemented as a method implemented in a computer or as a non-transitory computer-readable medium having computer-executable instructions stored therein. In an embodiment, when the computer-executable instructions are executed by the processor, the computer-executable instructions may perform the method according to at least one aspect of the present invention.

The transceiver 1020 may transmit or receive a wired signal or a wireless signal.

Further, the method according to the embodiment of the present invention may be implemented in the form of program instructions that can be executed through various computer units and recorded on computer readable media.

The computer readable media may include program instructions, data files, data structures, or combinations thereof. The program instructions recorded on the computer readable media may be specially designed and prepared for the embodiments of the invention or may be available well-known instructions for those skilled in the field of computer software. The computer readable media may include a hardware device configured to store and execute program instructions. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a RAM, or a flash memory, that is specially made to store and perform the program instructions. Examples of the program instruction include machine code generated by a compiler and high-level language code that can be executed in a computer using an interpreter and the like.

For reference, the components according to an embodiment of the present disclosure may be implemented in the form of software or hardware, such as a digital signal processor (DSP), a field programmable gate array (FPGA) or an application-specific integrated circuit (ASIC), and may perform given roles.

However, the “components” are not meanings limited to software or hardware, and each component may be configured to reside on an addressable storage medium and may be configured to operate on one or more processors.

Accordingly, for example, the component may include components, such as software components, object-oriented software components, class components, and task components, processes, functions, attributes, procedures, sub-routines, segments of a program code, drivers, firmware, a microcode, circuitry, data, a database, data structures, tables, arrays, and variables.

Components and functions provided in corresponding components may be combined into fewer components or may be further separated into additional components.

In the present disclosure, it will be understood that each block of the flowcharts and combinations of the blocks in the flowcharts may be executed by computer program instructions. These computer program instructions may be mounted on the processor of a general purpose computer, a special purpose computer, or other programmable data processing equipment, so that the instructions executed by the processor of the computer or other programmable data processing equipment create means for executing the functions specified in the flowchart block(s). These computer program instructions may also be stored in a computer-usable or computer-readable memory that can direct a computer or other programmable data processing equipment to implement a function in a particular manner. The computer program instructions may also be loaded on a computer or other programmable data processing equipment to cause a series of operational steps to be performed on the computer or other programmable data processing equipment to produce a computer-executed process, so that the instructions executing the computer or other programmable data processing equipment provide steps for executing the functions described in the flowchart block(s).

Furthermore, each block of the flowcharts may represent a portion of a module, a segment, or code, which includes one or more executable instructions for executing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

In this case, the term “ . . . unit” used in the present embodiment means software or a hardware component, such as an FPGA or an ASIC, and the “ . . . unit” performs specific tasks. However, the term “ . . . unit” does not mean that it is limited to software or hardware. The “ . . . unit” may be configured to reside on an addressable storage medium and configured to operate one or more processors. Accordingly, examples of the “ . . . unit” may include components, such as software components, object-oriented software components, class components, and task components, processes, functions, attributes, procedures, sub-routines, segments of a program code, drivers, firmware, a microcode, circuitry, data, a database, data structures, tables, arrays, and variables. The functionalities provided in the components and the “ . . . units” may be combined into fewer components and “ . . . units”, or may be further separated into additional components and “ . . . units”. Furthermore, the components and the “ . . . units” may be implemented to operate one or more CPUs within a device or a security multimedia card.

The aforementioned method of registering credentials, the aforementioned method of using credentials, and the aforementioned method of generating verifiable presentation through the credential manager and a corresponding digital signature have been described with reference to the flowcharts presented in the drawings. For a simple description, the method has been illustrated and described as a series of blocks, but the present disclosure is not limited to the sequence of the blocks, and some blocks may be performed in a sequence different from that of or simultaneously with that of other blocks, which has been illustrated and described in this specification. Various other branches, flow paths, and a sequence of blocks which achieve the same or similar results may be implemented. For example, in the method described with reference to FIG. 9, step S860, step S880, and step S890 may simultaneously occur.

Furthermore, all the blocks illustrated for an implementation of the method described in this specification may not be required.

The constructions of the present disclosure have been described in detail above with reference to the accompanying drawings, but are merely illustrative. A person having ordinary knowledge in the art to which the present disclosure pertains will understand that various modifications and changes are possible without departing from the technical spirit of the present disclosure. Accordingly, the scope of the present disclosure is defined by the appended claims rather than by the detailed description, and all changes or modifications derived from the scope of the claims and equivalents thereto should be interpreted as being included in the technical scope of the present disclosure.

### DESCRIPTION OF REFERENCE NUMERALS

1: credential management system

2: credential issuer, 2-1: credential issuer A, 2-2: credential issuer B

3: service provider

10: user terminal, 10-1: first user terminal, 10-2: second user terminal, 10-3: terminal

20: credential synchronization server

100, 100-1: digital wallet

200, 200-1, 200-2, 200-3: credential manager

210: user interface

220: user authentication unit

230, 230-1: credential information management unit

240: communication channel generation unit

250: credential synchronization unit

260: credential access control unit

270, 270-1: credential management interface

280, 280-1: key management interface

300, 300-1: secure element

401: app A, 402: app B

What is claimed is:

1. A credential management system comprising:
a credential synchronization server capable of transmitting and receiving information to and from a plurality of user terminals;
a first user terminal configured to be issued credentials and transmit, to the credential synchronization server, credential synchronization information comprising encoding information and private key information of the credentials; and
a second user terminal configured to receive the credential synchronization information from the credential synchronization server and generate “signed verifiable presentation” based on the credential synchronization information when receiving a submission request for the credentials from a service provider.

2. The credential management system of claim 1, wherein:
the first user terminal transmits, to the credential synchronization server, the credential synchronization information comprising a KeyID of the private key, and
the second user terminal receives a digital signature for the credentials by requesting the digital signature from the first user terminal when receiving the submission request, and generates the “signed verifiable presentation” based on the credential synchronization information and the digital signature.

3. The credential management system of claim 1, wherein:
the first user terminal transmits, to the credential synchronization server, the credential synchronization information comprising the encoding information of the credentials and encoding information of the private key, and
the second user terminal generates the digital signature for the credentials based on the private key encoding information in response to the submission request and generates the “signed verifiable presentation” based on the credential synchronization information and the digital signature.

4. A credential manager installed in a user terminal, comprising:
a credential management interface configured to receive a registration request for credentials from an app installed in the user terminal;
a credential information management unit configured to register the credentials and store encoding information of the credentials and private key information of the credentials in an internal repository of the credential manager; and
a credential synchronization unit configured to transmit credential synchronization information comprising the encoding information of the credentials and the private key information of the credentials to credential synchronization server capable of transmitting and receiving information to and from the user terminal and another terminal of the user.

5. The credential manager of claim 4, further comprising a user authentication unit configured to perform a user authentication procedure on the credentials in response to a registration request for the credentials,
wherein the credential information management unit registers the credentials and stores the credentials in the internal repository, when the user authentication procedure is completed.

6. The credential manager of claim 4, wherein the credential information management unit generates a digital signature based on private key encoding information when the private key information of the credentials for which digital signature has been requested by the app installed in the user terminal is private key encoding information.

7. The credential manager of claim 4, further comprising a key management interface capable of operating a secure element of the user terminal,
wherein the credential information management unit transmits a KeyID to the key management interface when the private key information of the credentials for which digital signature has been requested by the app installed in the user terminal is the KeyID and a terminal that owns an original of the private key of the credentials for which digital signature has been requested by the app is the user terminal, and
the key management interface invokes a digital signature function of a secure element of the user terminal by using the KeyID as an argument so that the secure element generates a digital signature for the credentials for which digital signature has been requested by the app by using a private key having the KeyID, receives the digital signature, and transmits the digital signature to the credential information management unit.

8. The credential manager of claim 4, wherein:
the credential synchronization unit receives, from the credential synchronization server, credential synchronization information comprising credential encoding information and private key information of credentials issued by the another terminal and transmits the credential synchronization information to the credential information management unit, and
the credential information management unit confirms a terminal that owns private key information of credentials for which digital signature has been requested by the app installed in the user terminal and an original of the private key, requests a digital signature from the another terminal when the private key information is a KeyID and the terminal that owns the original of the private key is the another terminal, and receives a digital signature using the private key from the another terminal.

9. The credential manager of claim 4, wherein:
the credential management interface receives at least any one of inquiry, update, and deletion requests for the credentials from the app installed in the user terminal, and
the credential information management unit performs any one of the inquiry, update, and deletion of the credentials in response to the request.

10. The credential manager of claim 4, wherein the credential synchronization information further comprises push information that enables a credential manager installed in the another terminal to invoke the credential manager.

11. The credential manager of claim 4, wherein the credential synchronization server transmits the credential synchronization information to the another terminal.

12. The credential manager of claim 4, further comprising a credential access control unit configured to control the app installed in the user terminal to access the credentials stored in the internal repository according to a given access policy.

13. The credential manager of claim 4, further comprising a key management interface capable of operating a secure element of the user terminal,
wherein the credential information management unit confirms a terminal that owns a type of the private key information of the credentials and an original of the private key of the credentials when the another terminal requests a digital signature for the credentials and transmits a KeyID to the key management interface when the private key information is the KeyID and the terminal that owns the original of the private key of the credentials is the user terminal, and
the key management interface invokes a digital signature function of a secure element of the user terminal by using the KeyID as an argument so that the secure element generates a digital signature for the credentials by using a private key having the KeyID, receives the digital signature, and transmits the digital signature to the credential information management unit.

14. A method of registering and using, by a credential manager installed in a user terminal, credentials, the method comprising:
a step of receiving a request for a registration of credentials from an app installed in the user terminal;
a step of registering the credentials when user authentication for the registration of the credentials is completed;
a credential synchronization step of transmitting encoding information and private key information of the registered credentials to a credential synchronization server accessible to another terminal of the user;
a step of selecting, by the app of the user terminal, credentials to be submitted to a service provider outside the user terminal and generating verifiable presentation by using the selected credentials;
a step of requesting, by the app, a digital signature for the verifiable presentation from the credential manager installed in the user terminal;
a step of determining, by the credential manager installed in the user terminal, information type of a private key of the credentials corresponding to the verifiable presentation;
a step of generating, by the credential manager installed in the user terminal, the digital signature by using the private key encoding information when the information type of the private key is private key encoding information; and
a step of generating, by the app, “signed verifiable presentation” by combining the digital signature with the verifiable presentation.

15. The method of claim 14, wherein the credential synchronization step comprises additionally transmitting, to the credential synchronization server, push information that enables a credential manager installed in the another terminal of the user to invoke the credential manager installed in the user terminal.

16. The method of claim 14, wherein the credential synchronization step comprises additionally transmitting, to the credential synchronization server, an identifier of the user terminal, a decentralized identifier (DID) of the credential manager, and ID information of an app of the user terminal whose access to the credentials has been blocked.

17. The method of claim 14, further comprising steps of:
after the step of determining the information type of the private key,
determining a user terminal that owns an original of the private key when the information type of the private key is a KeyID; and
generating the digital signature by invoking a digital signature function of a secure element embedded in the user terminal by using the KeyID of the private key as an argument when the user terminal that owns the original of the private key is the user terminal,
wherein the step of generating the “signed verifiable presentation” comprises invoking the digital signature function of the secure element and generating the “signed verifiable presentation” by combining the generated digital signature with the verifiable presentation.

18. The method of claim 14, further comprising a step of:
before the step of generating the verifiable presentation,
receiving credential synchronization information comprising credential encoding information and private key information of credentials issued by the another terminal of the user and storing the credential synchronization information,
the method further comprises steps of:
after the step of determining the information type of the private key,
determining a user terminal that owns the original of the private key when the information type of the private key is a KeyID; and
requesting a digital signature for the verifiable presentation from the another terminal when the user terminal that owns the original of the private key is the another terminal and receiving the digital signature for the verifiable presentation from the another terminal, and
the step of generating the signed verifiable presentation comprises generating the “signed verifiable presentation” by combining the digital signature received from the another terminal with the verifiable presentation.
